(19) United States
(12) Patent Application Publication
(10) Pub. No.: US 2008/0075932 A1
(43) Pub. Date: Mar. 27, 2008

(54) Printing Process and Printing Product Thus Obtained

(75) Inventor: Angelo Bartesaghi, Lecco (IT)

Correspondence Address: HEDMAN & COSTIGAN P.C., 1185 AVENUE OF THE AMERICAS, NEW YORK, NY, 10036, US

(73) Assignee: O-PAC S. R. L, Valmadrera (IT)

(21) Appl. No.: 11/792,401

(22) PCT Filed: Dec. 22, 2005
(86) PCT No.: PCT/EP05/14175

§ 371 Date: Jun. 5, 2007

(30) Foreign Application Priority Data
Dec. 23, 2004 (IT) MI2004A002489

(51) Int. Cl. B41F 31/00; B41M 5/00

(52) U.S. Cl. 428/195.1; 101/491; 424/402

(57) ABSTRACT

The present invention concerns a process for printing with a non-toxic substance on a printing support (2). The process has a printing step in which at least one side of the printing support (2) is printed in at least one portion (5, 6) with a melted water-insoluble substance.

The present invention concerns a process for printing on a printing support, such as fabric, non-woven fabric and paper, and products obtained with such a process.

In particular, the invention concerns disposable hygienic wipes imbibed with disinfectant, deodorising and/or detergent liquids and the relative process for making them.

Wipes of this type are now well known and, thanks to their being extremely practical, are used daily.

Indeed, they are widely used without water, both to clean the hands and to clean more sensitive areas, above all in newborn babies, as well as in many other applications.

The use for which they are intended, in other words contact with the skin and sensitive areas, necessitates very high hygiene standards and the absence of contamination, during the production process.

Furthermore, the inks are generally very expensive, and due to the particular synthetic compositions with which they are formed they interact with the scents or the additional substances with which this type of wipe or napkin is generally treated and/or imbibed.

In general, then, such inks, coming into contact with the different solutions with which the wipes are treated, may fade or disperse, thus reducing the anchorage of the writing and/or decorative element to the printing support.

Following such reduction of anchorage to the printing support, there is a loss of definition of the printed subject.

For such reasons, up to now it has been impossible to apply decorative patterns, trademarks or any type of writing in non-toxic manner to such wipes.

Moreover, for such wipes, which are sold in suitable rigid or flexible packets equipped with an opening, in the current state of the art it is very difficult to remove the wipes from the opening.

Indeed, the folded flaps of the wipe tend to stick to each other and to those of the wipe beneath.

In light of the above, there is a clear need to be able to have disposable wipes and a manufacturing process, like the one according to the present invention, which allows the problems of the prior art to be solved.

Therefore, the purpose of the present invention is that of providing hygienic wipes and a manufacturing process that allows decorative patterns, trademarks or writing to be inserted on them without causing the product to be contaminated.

Another purpose of the present invention is that of providing a wipe equipped with means that make it easier to remove it from the packet without lowering the required hygiene standards and/or contaminating the wipes.

A further purpose of the present invention is that of making a printing process on a printing support, such as fabric, non-woven fabric or paper, which is not toxic and which does not contaminate the product to be printed.

A further purpose of the present invention is that of making a printing process on a printing support, such as fabric, non-woven fabric and paper, in which the printed substance is well anchored on the support, independent from the additional substances with which the same support must be treated after the printing.

Finally, another purpose of the present invention is that of providing a printing process on a support, such as fabric, non-woven fabric or paper that is simple and cost-effective.

These and other purposes are accomplished by the disposable wipes and by the printing process according to the present invention, which has the characteristics of the attached claims 1 and 14.

Other characteristics of the invention are highlighted by the subsequent claims.

Further characteristics and advantages of the present invention shall become clearer from the present description, given for illustrating and not limiting purposes, with reference to the attached drawings, in which:

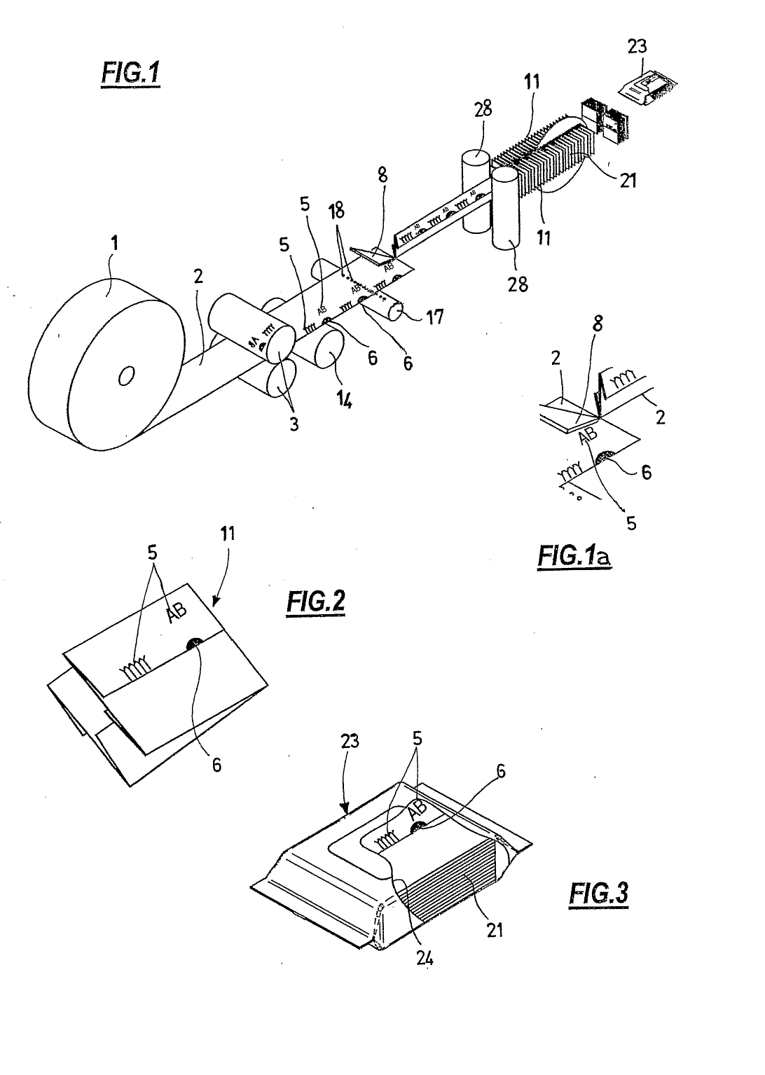

FIG. 1 schematically shows some steps of a production process of disposable wipes according to the present invention;

FIG. 1a schematically shows a detail of a step of the production process of disposable wipes according to the present invention;

FIG. 2 shows a perspective view of a first way of folding a wipe according to the present invention; and

FIG. 3 is a perspective, partially separated view of a packet containing a pile of wipes according to the present invention.

With reference to FIG. 1, a series of steps of the process according to the present invention for printing with a non-toxic substance on a printing support 2, such as fabric, non-woven fabric or paper, are shown.

Advantageously according to the present invention, the process comprises a printing step in which at least one side of the printing support 2 is printed in at least one portion 5, 6 with a melted, non-toxic, water-insoluble substance in order to reproduce on the printing support 2 at least one decorative element and/or writing and/or trademark.

The insoluble non-toxic substance is selected from amongst paraffins, natural waxes and/or their mixtures with a weight percentage greater than 70%.

According to another aspect of the present invention, the insoluble substance is mixed with dying substances and/or non-toxic pigments.

In particular, the insoluble substance deposited on the support is composed of 99% wax or paraffin and/or their mixture and 1% non-toxic pigment.

Furthermore, the pigment used to dye the wax is non-soluble in water.

It is observed, moreover, that the printing support is “non-woven” or a “tissue” with diverse contents and mixtures of cellulose-polyester-viscose-polypropylene.

Preferably, the basic weights of the non-woven fabric utilised are comprised within the range from 20 g/m² to 100 g/m².

The process of printing on the napkin according to the present invention is made with the purpose of obtaining a valid result from the aesthetic standpoint: designs, lines, writing, trademarks made with one or more colours, in order to improve the finished product from the graphical/aesthetic point of view.

Hereafter, as an example, a process according to the present invention for producing disposable wipes 11 shall be described, although such a method can be applied for the production of other products without departing from the scope of protection of the present invention.

In detail, a reel 1 of a band 2 of material for hygienic wipes, such as paper, fabric or non-woven fabric, which constitutes the printing support 2, is unwound.

The band 2, which in this case represents the printing support, is made to follow a path along which it is subjected, as well as to the unwinding and printing steps, to the steps of:

b) drying the portion 5 or 6 of the printed printing support, carried out downstream of the printing step;

c) cutting the printed band into wipes 11 of the desired size, carried out downstream of the drying step; and

d) packaging the printed wipes 11.

In the first step, therefore, the band 2 is printed on at least one side and in at least one portion 5 with a water-insoluble substance.

The pattern/design may be printed in a precise position with respect to the border of the napkin.

In particular, the band is printed in some portions 5 with a water-insoluble substance like for example paraffin so as to insert decorative patterns, trademarks or writing on the band or printing support 2 without contaminating it and, consequently, without contaminating the wipes 11 that shall be formed from it.

Preferably, the insoluble substance is a mixture composed of 99% wax or paraffin and 1% non-toxic pigment.

For such a purpose the printing step also comprises the steps of:

g) heating the non-toxic water-insoluble substance;

h) mixing the non-toxic water-insoluble substance with the aforementioned dying substances and/or pigments;

i) spreading the non-toxic water-insoluble substance, at this point heated and mixed, on printing cylinders.

In particular, the heating takes place through a known resistance, but it could, nevertheless, take place with hot air jets, infrared bulbs or any equivalent means.

During the heating step, the paraffin is taken to a temperature within the range between 50° C. and 100° C., preferably between 60° C. and 80° C.

It is observed, moreover, that the technology utilised for depositing the wax-based insoluble substance on the support is derived from a known printing technique. In particular, a method derived from silk-screen printing is used, but also rotogravure printing may be used without departing from the scope of protection of the present invention.

During the printing step, carried out with known printing means 3, at least one edge portion can also be printed, again with dyed paraffin, so as to make a tab 6. The tab 6 shall make the gripping point easier for the user to see, at the same time making it easier to remove the wipe 11 from the container in which it shall be placed.

The edge portion printed with the insoluble substance to create the tab 6 creates, indeed, an impermeable layer that avoids such a portion sticking to the flaps of the wipe below.

In FIG. 1, said areas 6 are placed close to just one edge of the band 2, but can also be situated on the opposite edge or in different positions according to the different ways of folding to which the wipes 11 and/or the band 2 will be subjected.

Preferably, in the process for producing wipes illustrated above, during the printing step, the printing support 1 is printed on both sides.

After the printing step, the band or printing support 2 is subjected to a drying step that improves the adhesion between the support 2 and the wax or paraffin.

For such a purpose, the printed support 2 is passed onto a cooled cylinder 14.

Alternatively, the drying step could simply consist of exposing the band 2, downstream of the printing step, to the air for a predetermined time period, before the subsequent operation.

Also optionally, the process according to the present invention for producing wipes 11 can comprise an imbibing step, a calendering step and a folding step.

During the imbibing step the printed support 2 is imbibed with different types of solution such as deodorants, disinfectants and/or detergents.

In particular, the imbibing step comprises a step in which the printed support 2 is passed onto a roller 17 equipped with orifices 18 from which the foreseen imbibing solution comes out to be absorbed by the support in transit.

Alternatively, the imbibing step could be carried out by subjecting the printed support 2 to jets of the deodorant and/or detergent substance, delivered by suitable nebulizer nozzles or by dipping into a tank containing the deodorant and/or detergent substance.

Although in FIG. 1 the imbibing step is illustrated upstream of the packaging step, it could, nevertheless, be carried out before or after other steps of the process without departing from the scope of protection of the present invention.

After the printing process, as described above, the printed fabric is then imbibed or impregnated with diverse solutions in relation with the specific application, for example make-up removal, child hygiene, private parts hygiene etc.

It is observed that for the present invention it is of fundamental importance that whatever the composition of the imbibing solutions, this does not interact with the printed wax.

The solution utilised is generally a cosmetic lotion for the cure and hygiene of the person, in other words an aqueous mixture of chemical components of natural and synthetic origin, which are in accordance to that set forth by the current European legislation (EEC Directive 76/768 and subsequent modifications). The cosmetic lotions may be simple, water-based detergent bases with the addition of surface-active agents and active principles usually of plant origin, or they may be lotions also containing a lipidic phase which confers a greater skin-compatibility to the lotion. The percentage of lipids may be greater than that of water, and in this case one would speak of “water in oil” emulsions; when on the other hand there is a greater percentage of water, one would speak of “oil in water” emulsions.

The calendaring step is generally carried out directly upstream of the printing step and acts to make the thickness of the support 2 to be printed uniform.

In FIG. 1, the unwound band or printing support 2 is printed, then cooled through the cylinder 14 and then imbibed by means of the cylinder 17.

Then the band 2 is folded longitudinally, through the folder 8, into a plurality of parts.

The band 2, thus folded longitudinally, is sent to a folding group of the type with counter-rotating rollers 28.

The counter-rotating rollers 28 allow the printing support 2 to be folded transversally into two parts.

The folding step could also be carried out through other folders (mechanical or using air suction) without departing from the scope of protection of the present invention.

Moreover, the folding step, which could also involve folding in a different way from that illustrated, could be carried out before or after another step of the process according to the present invention.

Downstream of the folding, as shown in FIG. 1, piles 21 are finally formed, in a per se known way, consisting of a predetermined number of wipes 11 and such piles are divided into two cutting the wipes 11 with the blade 9 to reduce their format.

Alternatively, such a separation can also take place before or during any step of the process according to the present invention, for example, through many cutting blades or by punching.

The piles of wipes, thus obtained, are thus packaged into suitable packets 23 taking care for the flap of the folded wipe on which the tab 6 is placed to be facing towards the opening 24 of the packets 23.

Advantageously according to the present invention, the printing with insoluble wax-based substance is in fact in line with the productive process of the moisturised napkin. Thus one single production line is used which, beginning from the non-woven fabric reel, unwinds, prints, bathes, folds, cuts and packages in the desired quantity.

In FIG. 1 it can be seen that the fabric has portions printed with dyed paraffin 5, and optionally one or more tabs 6, again printed with dyed paraffin, suitable for highlighting a gripping point for the user and for making it easier to remove the wipe from the container in which it shall be placed.

In particular, in FIG. 1a it can be seen how the portions 5 are made from letters printed with paraffin, but they could be represented by decorative patterns, designs or trademarks without departing from the scope of protection of the present invention.

In FIG. 2 the wipe 11 is shown folded according to a first way of folding, although different ones can be foreseen.

It can be seen that, advantageously according to this way of folding, the edge of the wipe provided with the tab 6 is positioned on top, in other words on a side of the wipe 11 that shall be placed facing the opening 24 of the container, as shown in FIG. 3.

In such a way, the tab 6 can easily be gripped with two fingers to make it easier to remove the whole wipe 11 through the opening of the container.

The described process and device therefore represent an optimal solution to the problems of the current state of the art, providing hygienic wipes provided with printed portions that do not contaminate the product.

Such wipes are also easy to handle and remove even when impregnated with disinfectant and/or detergent and/or deodorising liquids.

The present invention has been described for illustrating but not limiting purposes, according to its preferred embodiments, but it should be understood that variations and/or modifications can be brought by men skilled in the art without for this reason departing from the relative scope of protection, as defined by the attached claims.

1. Process for printing of at least one decorative element and/or writing and/or trademark with a nontoxic substance on a printing support (2), characterised in that it comprises a step in which said at least one decorative element and/or writing and/or trademark is printed and well anchored on at least a portion (5,6) of at least one side of said printing support (2) with a melted water-insoluble substance based on paraffins and/or natural waxes and/or their mixtures, said water-insoluble substance comprising natural wax and/or paraffin in a weight percentage greater than 70%.

2. Process according to claim 1, characterised in that said printing support (2) is selected from amongst fabric, non-woven fabric or paper with diverse contents and mixtures of cellulose and/or polyester and/or viscose and/or polypropylene.

3. (canceled)

4. Process according to claim 1, characterised in that said insoluble substance is mixed with dying substances and/or non-toxic pigments.

5. Process according to claim 4, characterised in that the substance deposited on the printing support (2) is composed of 99% wax or paraffin and 1% non-toxic pigment.

6. Process according to claim 1, characterised in that said printing support (2) comprises a basic weight of “non-woven fabric” comprised within the range from 20 g/m² to 100 g/m².

7. Process according to claim 1, characterised in that said printing step is realised through silk-screen printing.

8. Process according to claim 1, characterised in that said printing step is realised through rotogravure printing.

9. Process according to claim 1, characterised in that it also comprises the following steps:
a) unwinding said printing support (2) out flat to prepare for the printing step;
b) drying said printing support (2), downstream of said printing step;
c) cutting said printing support (2), downstream of said drying step, into the desired size;
d) packaging said printing support (2).

10. Process according to claim 9, characterised in that it also comprises the following steps:
e) calendaring, downstream of said winding to make the thickness of the printing support (2) uniform, upstream of said printing step;
f) imbibing to imbibe said printed support (2), with a deodorising, cleaning and/or detergent product.
g) folding to fold the printed support for packaging.

11. Process according to claim 1, characterised in that the printing step comprises a step of:
h) heating said non-toxic water-insoluble substance;
i) mixing said non-toxic water-insoluble substance with dying substances and/or non-toxic pigments;
j) application of said non-toxic water-insoluble substance, heated and mixed, on said printing support through a printing cylinder.

12. Process according to claim 11, characterised in that the heating step of said non-toxic water-insoluble substance is carried out through an electrical resistance.

13. Process according to claim 12, characterised in that during the heating step the insoluble substance is taken to a temperature of between 50° and 100° C., preferably between 60° and 80° C.

14. Process according to claim 9, characterised in that said drying step comprises a step in which the printed support is passed onto a cool roller (14).

15. Process according to claim 11, characterised in that the imbibing step comprises a step in which the printed support is passed onto a roller (17) equipped with orifices (18) from which said deodorising and/or detergent substance comes out.

16. Process according to claim 11 characterised in that said imbibing step comprises a step in which the printed support (2) is subjected to jets of said deodorising and/or detergent substance.

17. Process according to claim 11 characterised in that it also comprises the following step:
1) forming piles (21) with a predetermined number of wipes (11) for packaging.

18. Disposable hygienic wipe characterised in that it comprises at least one portion (5, 6) on which at least one decorative element and/or writing and/or trademark is printed and well anchored using a melted water-insoluble substance selected from amongst paraffins, natural waxes and/or their mixtures, said water-insoluble substance comprising natural wax and/or paraffin in a weight percentage greater than 70%.

19. Disposable hygienic wipe according to claim 18, characterised in that it comprises at least one portion (5) printed with a melted water-insoluble substance mixed with dying substances and/or non-toxic pigments.

20. Disposable hygienic wipe according to claim 18, characterised in that it comprises at least one portion printed with a melted water-insoluble substance mixed with non-toxic dying substances and/or pigments suitable for defining a coloured removal tab (6).

21. Disposable hygienic wipe according to claim 20, characterised in that it comprises at least one portion (5) printed with a melted water-insoluble substance based on wax and/or paraffin mixed with non-toxic dying substances and/or pigments on both sides of said wipe.
